(19) United States
(12) Patent Application Publication
(10) Pub. No.: US 2021/0136140 A1
(43) Pub. Date: May 6, 2021

(54) USING SERVICE CONTAINERS TO IMPLEMENT SERVICE CHAINS

(71) Applicant: VMware, Inc., Palo Alto, CA (US)

(72) Inventors: Jeremy Tidemann, Urbana, IL (US); Constantine Polychronopoulos, Saratoga, CA (US); Marc-Andre Bordeleau, Shawinigan (CA); Edward Choh, Richmond (CA); Ojas Gupta, Mountain View, CA (US); Robert Kidd, Champaign, IL (US); Raja Kommula, Cupertino, CA (US); Georgios Oikonomou, Patras (GR); Mingjie Zhao, Sunnyvale, CA (US)

(21) Appl. No.: 16/668,477

(22) Filed: Oct. 30, 2019

(51) Int. Cl. H04L 29/08; H04L 12/851; H04L 12/859

(52) U.S. Cl. CPC H04L 67/1012; H04L 67/16; H04L 47/2475; H04L 47/2483; H04L 47/2441

(57) ABSTRACT

Some embodiments of the invention provide novel methods for performing services on data messages passing through a network connecting one or more datacenters, such as software defined datacenters (SDDCs). The method of some embodiments uses service containers executing on host computers to perform different chains (e.g., ordered sequences) of services on different data message flows. For a data message of a particular data message flow that is received or generated at a host computer, the method in some embodiments uses a service classifier executing on the host computer to identify a service chain that specifies several services to perform on the data message. For each service in the identified service chain, the service classifier identifies a service container for performing the service. The service classifier then forwards the data message to a service forwarding element to forward the data message through the service containers identified for the identified service chain. The service classifier and service forwarding element are implemented in some embodiments as processes that are defined as hooks in the virtual interface endpoints (e.g., virtual Ethernet ports) of the host computer's operating system (e.g., Linux operating system) over which the service containers execute.

Datacenters today use a static, configuration intensive way to distribute data messages between different application layers and to different service layers. A common approach today is to configure the virtual machines to send packets to virtual IP addresses, and then configure the forwarding elements and load balancers in the datacenter with forwarding rules that direct them to forward VIP addressed packets to appropriate application and/or service layers. Another problem with existing message distribution schemes is that today's load balancers often are chokepoints for the distributed traffic. Accordingly, there is a need in the art for a new approach to seamlessly distribute data messages in the datacenter between different application and/or service layers. Ideally, this new approach would allow the distribution scheme to be easily modified without reconfiguring the servers that transmit the data messages.

### BRIEF SUMMARY

Some embodiments of the invention provide novel methods for performing services on data messages passing through a network connecting one or more datacenters, such as software defined datacenters (SDDCs). The method of some embodiments uses service containers executing on host computers to perform different chains (e.g., ordered sequences) of services on different data message flows. For a data message of a particular data message flow that is received or generated at a host computer, the method in some embodiments uses a service classifier executing on the host computer to identify a service chain that specifies several services to perform on the data message.

For each service in the identified service chain, the service classifier identifies a service node for performing the service. Some or all of the service nodes in a service chain are service containers in some embodiments. The service classifier then forwards the data message to a service forwarding element to forward the data message through the service nodes identified for the identified service chain. As further described below, the service classifier and service forwarding element are implemented in some embodiments as processes that are defined as hooks in the virtual interface endpoints (e.g., virtual Ethernet ports) of the host computer's operating system (e.g., Linux operating system) over which the service containers execute.

For the particular data message flow, the service classifier in some embodiments identifies a service container for at least one service in the identified service chain by performing load balancing operations to select particular service containers from a set of two or more candidate service containers for the service. In some embodiments, the service classifier performs this load balancing operation to select one service container from multiple candidate service containers for two or more (e.g., all) of the services in the identified service chain.

For a particular service, the service classifier in some embodiments performs the load balancing operation by directing a load balancer that is specified for the particular service to select a container from the set of candidate service containers for the particular service. In some embodiments, the load balancing operation uses statistics regarding data messages processed by each container in the candidate container set to select one particular container from the set for the particular data message flow.

For the particular data message flow, the service classifier in some embodiments specifies a service path identifier (SPI) that identifies a path through the containers selected for implementing the identified service chain, and provides this service path identifier to the service forwarding element to use to perform its classification operations for forwarding the data messages of this flow. In other embodiments, the service forwarding element does not use the service path identifier for forwarding the data messages of the particular data message flow, but uses MAC redirect for specifying forwarding rules for directing the data messages of this flow between successive service containers in the service path.

Conjunctively with either of these forwarding approaches, some embodiments use the specified service path identifier to select the service path for a reverse data message flow that is sent in response to the particular data message flow (e.g., by the destination of the particular data message flow). This approach ensures that in these embodiments the same set of service containers examine both the initial data message flow in the forward direction and the responsive data message flow in the reverse direction.

In some of the embodiments that use the MAC redirect approach for forwarding data messages to different service containers in the service path, the service forwarding element is implemented (1) by the virtual interface endpoints in the OS namespace that is used to define a virtual forwarding element (e.g., virtual switch or virtual bridge) in the OS, and (2) by a virtual interface endpoint in a container namespace of each service container. These virtual interface endpoints are configured to perform match-action forwarding operations needed for implementing the MAC redirect forwarding.

In some embodiments, these match-action operations include match classification operations that compare layer 2 (L2) source and/or destination network address of the data message and layer 3 (L3) source and/or destination network address of the data message with selection criteria of forwarding rules. The L3 source and/or destination network addresses are used in some embodiments to differentiate egress data messages exiting a subnet from ingress data messages entering a subnet. In some embodiments, the match-action operations include action operations that modify the L2 destination MAC address of the data messages as these embodiments use MAC redirect to forward the data messages to successive service containers.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 illustrates a software defined datacenter (SDDC) that uses the service-performance methods of some embodiments to process data messages originating from, and/or received at, the SDDC.

FIG. 2 illustrates how some embodiments implement the service forwarding element and the service classifier within a Linux operating system (OS) of a host computer.

FIG. 3 illustrates a process that the service classifier performs in some embodiments.

FIG. 4 illustrates the service classifier of some embodiments interacting with several other modules to perform service classification.

FIG. 5 presents a process that conceptually illustrates the operation of the service forwarding element in forwarding a data message through a service path identified by the service classifier.

FIG. 6 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide novel methods for performing services on data messages passing through a network connecting machines in one or more datacenters, such as software defined datacenters (SDDCs). The method of some embodiments uses service containers executing on host computers to perform different chains of services on different data message flows. Service chains include one or more service nodes, each of which performs a service in the service chain. In some embodiments, some or all of the service nodes are service containers.

Containers in some embodiments are constructs that run on top of an operating system (OS) of a host computer. In some embodiments, the host operating system uses name spaces to isolate the containers from each other and therefore provides operating-system level segregation of the different groups of applications that operate within different containers. Examples of containers include Docker containers, rkt containers, and containers executing on top of hypervisors, such as ESXi.

As used in this document, data messages refer to a collection of bits in a particular format sent across a network. One of ordinary skill in the art will recognize that the term data message may be used herein to refer to various formatted collections of bits that may be sent across a network, such as Ethernet frames, IP packets, TCP segments, UDP datagrams, etc. Also, as used in this document, references to L2, L3, L4, and L7 layers (or layer 2, layer 3, layer 4, layer 7) are references respectively to the second data link layer, the third network layer, the fourth transport layer, and the seventh application layer of the OSI (Open System Interconnection) layer model.

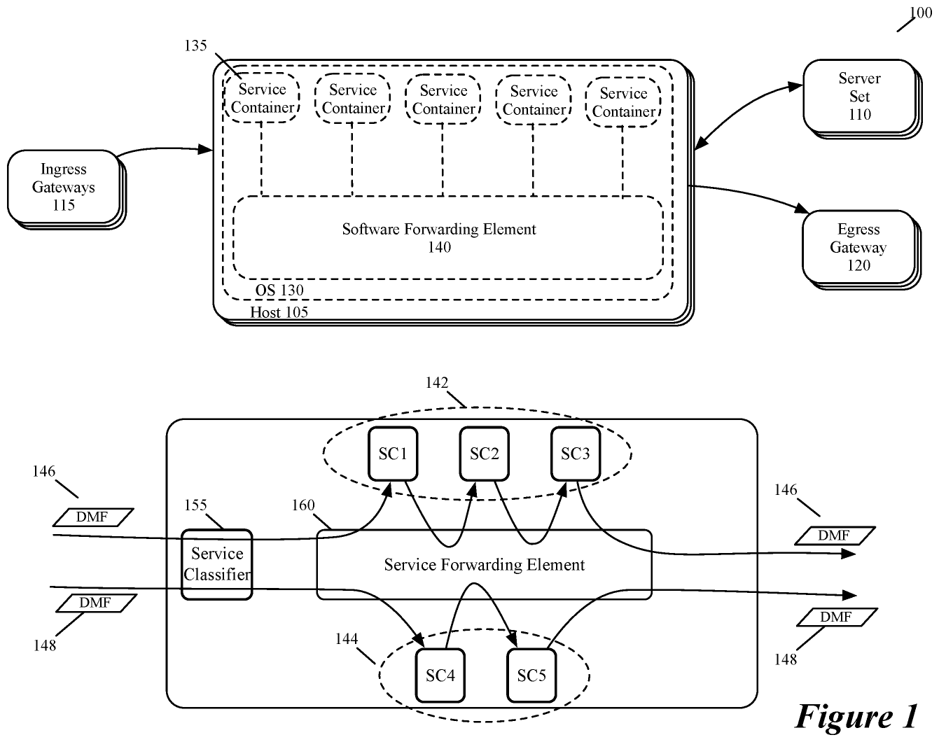

FIG. 1 illustrates an SDDC 100 that uses the service-performance methods of some embodiments to process data messages originating from, and/or received at, the SDDC. In some embodiments, the SDDC is part of a telecommunication network (e.g., a 5G telecommunication network) for which multiple network slices can be defined. A data message flow can be associated with a network slice, and one or more service chains can be defined for each network slice. Each service chain in some embodiments specifies one or more ordered sequence of service operations (e.g., compute operations, forwarding operations, and/or middlebox service operations, etc.) to perform on the data message flows associated with the chain's network slice.

In a 5G telecommunication network, the service operations include virtual network functions (VNFs) that are performed on the data messages. Examples of network slices for a 5G telecommunication network include a mobile broadband slice for processing broadband data, an IoT (Internet of Things) slice for processing IoT data, a telemetry slice for processing telemetry data, a VOIP (voice over IP) slice for voice over IP data, a video conferencing slice for processing video conferencing data, a device navigation slice for processing navigation data, etc.

As shown, the SDDC 100 includes host computers 105, managing servers 110, ingress gateways 115, and egress gateways 120. The ingress/egress gateways 115 and 120 allow data messages to enter and exit the datacenter. In some embodiments, the same set of gateways can act as ingress and egress gateways, as they connect the SDDC to an external network, such as the Internet. In other embodiments, the ingress and egress gateways are different as the ingress gateways connect the SDDC to one network (e.g., a private telecommunication network) while the egress gateways connect the SDDC to another network (e.g., to the Internet). Also, in some embodiments, one or both of these sets of gateways (e.g., the ingress gateways or the egress gateways) connect to two or more networks (e.g., an MPLS network and the Internet).

As further shown, the host computers execute operating systems 130, service containers 135 and software forwarding elements 140. The operating system (OS) 130 in some embodiments is Linux. This OS executes on top of a hypervisor in some embodiments, while it executes natively (without a hypervisor) over the host computer in other embodiments. The service containers 135 and the software forwarding elements 140 are deployed and configured by the managing servers 110 to implement chains of service operations.

The managing servers 110 in some embodiments include managers through which service chains can be defined and managed, and controllers through which the service containers 135 and the software forwarding elements 140 can be configured. In other embodiments, a common set of servers performs both the management and control operations. To operate service chains, the managing servers 110 in some embodiments configure each host computer 105 and its software forwarding element to implement a service classifier 155 and a service forwarding element 160.

For a data message of a particular data message flow that is received at a host computer, the service classifier 155 executing on the host computer 105 identifies a service chain that specifies several services to perform on the data message. The received data message in some cases originate from a source machine executing on the host computer, while in other embodiments was forwarded by a forwarding element (e.g., front end load balancer) operating outside of the host computer.

For each service in the identified service chain, the service classifier 155 identifies a service container 135 to perform the service. In some embodiments, the service classifier 155 of one host computer identifies all service containers for a service chain to be on its host computer. In other embodiments, the service classifier can select service containers on different hosts to perform some or all of the service operation of the identified service chain. The set of service containers that are identified for implementing a service chain represent a service path through the network.

After identifying the service chain and the service containers to implement the service chain (e.g., after identifying the service path), the service classifier 155 passes the data message to the service forwarding element 160 to forward the data message to the service containers identified for the identified service chain. In some embodiments, the service forwarding element 160 executes on the service classifier's host computer. In other embodiments where the service containers of the identified service path can be on different host computers, the service forwarding element 160 is a distributed forwarding element (e.g., a logical forwarding element) that spans the multiple hosts that execute the service containers of the service path.

In some embodiments, the service forwarding element 160 performs L2-match operations with L2 MAC redirect action operations to forward data messages to different service containers in the service path. In other embodiments, the service forwarding element uses service path identifiers (that identify the service paths) to perform its match operations, as further described below.

FIG. 1 illustrates the service classifier 155 selecting two different service paths 142 and 144 for two different data message flows 146 and 148, and the service forwarding element 160 forwarding these data message flows along the service containers in each path. The service forwarding element forwards the data message flow 146 along service containers SC1, SC2 and SC3 for service path 142, while forwarding the data message flow 148 along the service containers SC4 and SC5 for service path 144. The service forwarding element then forwards both of these data message flows out of the SDDC 100. Once a data message is processed by the service containers of a service chain, a service forwarding element in some embodiments can also forward the data message to another host computer or another machine, application or middlebox service operating on the same host computer or different host computer in the SDDC.

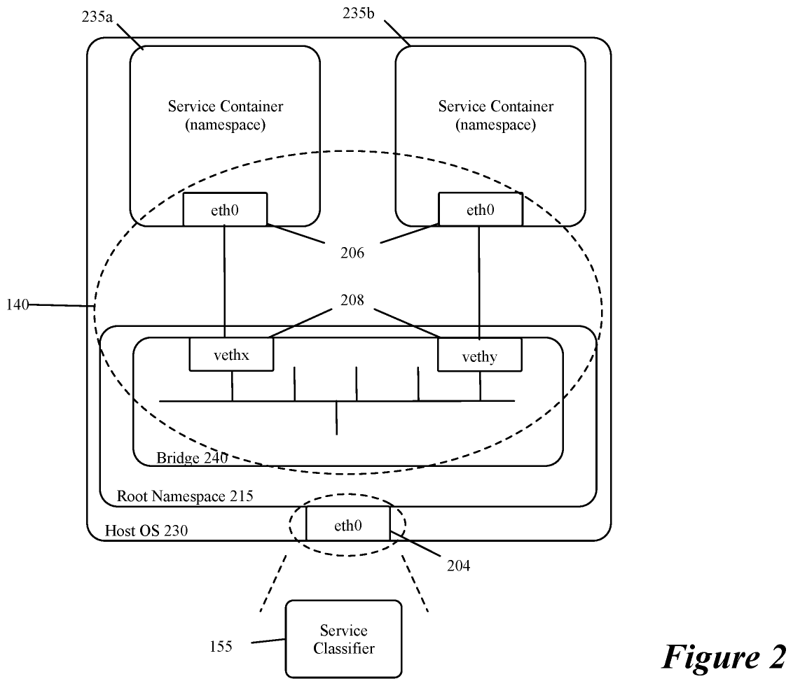

FIG. 2 illustrates how some embodiments implement the service forwarding element and the service classifier within a Linux OS 230 of a host computer. As shown, a service classifier 155 in some embodiments is implemented as a hook function in an ingress-side virtual interface endpoint 204 (e.g., Ethernet port) of the Linux OS 230. This port 204 in some embodiments serves as an interface with a network interface controller (NIC) of the host computer. In some embodiments, the service forwarding element 160 is implemented in part by a Linux bridge 240 inside its root namespace 215, and in other part by hook functions in the virtual interface endpoints 206 (e.g., Ethernet ports) of the service containers 235 and in the virtual interface endpoints 208 defined in the Linux namespace.

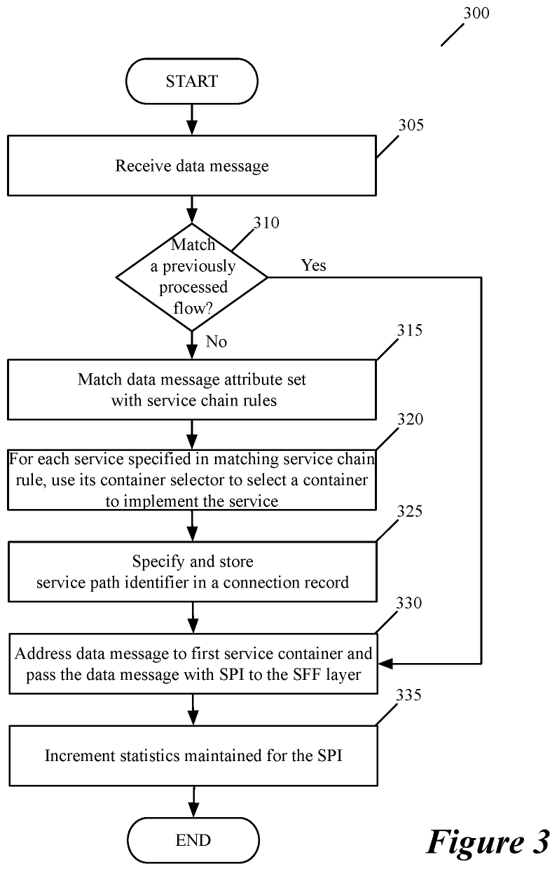

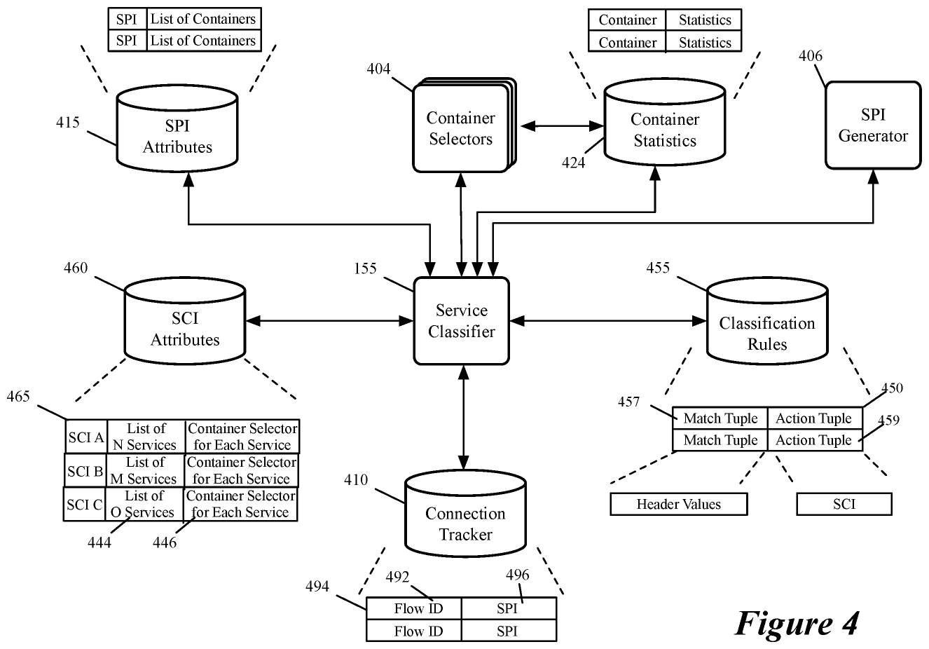

FIG. 3 illustrates a process 300 that the service classifier 155 performs in some embodiments. The classifier performs this process each time it receives a data message. To perform this process, the service classifier 155 interacts with several other modules executing on its host computer. As shown in FIG. 4, these other modules in some embodiments include container selectors 404 and SPI generator 406.

As shown, the process 300 starts (at 305) when the service classifier 155 receives a data message for processing. At 310, the service classifier 155 determines whether it has previously processed another data message that is in the same flow as the received data message. If so, it transitions to 330 to pass the received data message to a first service container that is identified by a record that the service classifier previously created and stored for the processed flow in a connection tracker 410, as further described below.

In some embodiments, the record that was previously created in the connection tracker might be for a related flow in the reverse direction. Specifically, in some embodiments, the record that the service classifier creates for a first data message flow in a first direction (e.g., a flow exiting the SDDC) is used by the service classifier to process a second data message flow in a second direction (e.g., a flow entering the SDDC) that is received in response to the first data message flow, as further described below.

The service classifier does this in order to use the same service path (e.g., the same set of service containers) to process the reverse second flow as it did for the initial first flow. In these embodiments, the connection tracker record is for a bi-directional flow, instead of just being for a unidirectional flow. In other embodiments, the service classifier creates two records when processing the first data message flow, one for the forward direction and the other for the reverse direction, as the connection-tracker records in the forward and reverse directions are related but not identical.

When the service classifier 155 determines (at 310) that it has not previously processed another data message in the same flow as the received data message, it uses (at 315) the received data message's attribute set (e.g., its header values) to perform a classification operation to identify a service chain identifier for a service chain that has to be performed on the data message's flow. In some embodiments, the data message's attribute set that is used for the classification match operation is the data message flow's five tuple identifier (e.g., source and destination IP, source and destination port, and protocol), or its seven tuple identifier (i.e., its five tuple identifier plus source and destination MAC addresses).

FIG. 4 shows the service classifier 155 performing its service classification operation by referring to service classification rules 450 that are stored in classification rule storage 455. As shown, each classification rule includes a match tuple 457 and an action tuple 459. The match tuple includes one or more header values (e.g., five or seven tuple identifiers), while the action tuple 459 includes a service chain identifier (SCI).

After matching a data message's attribute set with the match tuple 457 of a service classification rule 450, the service container 155 (at 320) retrieves the SCI from the matching service classification rule's action tuple 459 and uses the retrieved SCI to identify a record 465 in an SCI attribute storage 460. Each record 465 in the SCI attribute storage correlates an SCI with an ordered list of services 444 of the service chain identified by the SCI, and a list 446 of container selectors 404 for selecting the containers to perform the services in the chain.

At 320, the service classifier 155 in some embodiments selects a service container for each service specified in the identified SCI record 465 in the storage 460, by using the container selector 404 specified for the service in the identified SCI record. When multiple candidate service containers exist for performing one service, the specified container selector for that service in some embodiments performs a load balancing operation to select one particular candidate service container for the received data message's flow.

In some embodiments, such a load balancing operation uses statistics (stored in container statistics storage 424) regarding data messages processed by each candidate service container to select the particular service container. As further described below, the service classifier updates the statistics for the containers associated with a service path each time that it processes a data message. In some embodiments, the load balancing operations of the container selectors are designed to distribute the data message load evenly across the candidate service containers, or unevenly based on a weighted distribution scheme.

Also, in some embodiments, the container selectors for different services in a service chain work in conjunction to select the containers in a service path, e.g., in embodiments where selection of a first service container for a first service in the service path necessitates the selection of a second service container for a second service in the service path. Such is the case in some embodiments when one service container cannot be part of two different service paths (i.e., when two service paths cannot overlap).

Some embodiments group the containers into pods, with each pod comprising one or more service containers that are guaranteed to be co-located on the same host computer. Each pod in some embodiments is implemented by one virtual machine. In some embodiments, two or more of the service containers for a service path (e.g., all the service containers for the service path) are in the same pod, and two or more pods are candidates for implementing the same service chain. In some of these embodiments, the container selector 404 is a load-balancing pod selector that selects one pod from several pods that are candidates for implementing the service path of a service chain identified by the service classifier 155.

Next, at 325, the service classifier generates a SPI for the service path specified by the containers selected at 320, and stores the generated SPI in the connection tracker 410 for the received data message's flow identifier (e.g., its five or seven tuple identifier). To generate the SPI, the service classifier uses the SPI generator 406. In some embodiments, the SPI generator 406 uses a set of rules to define the SPI for a service path based on the identifiers associated with the containers selected at 320. For instance, the SPI is defined in some embodiments to be a concatenation of the UUID (universally unique ID) of the service path containers. In some embodiments, the UUIDs are concatenated in the order of the service containers in the service path.

The service classifier stores (at 325) the generated SPI in the connection tracker 410 for the received data message's flow identifier so that it can later use this SPI to identify the service path (in the SPI attribute storage 415) for a subsequent data message in the same flow as the currently processed data message. To do this, the service classifier would match the subsequent data message's flow ID (e.g., its five or seven tuple identifier) with the flow ID in a match tuple 492 of a record 494 in the connection tracker 410, and then retrieve the SPI specified by the action tuple 496 of the record with the matching flow ID.

As mentioned above, the service classifier in some embodiments uses the SPI record in the connection tracker 410 to process data messages of a flow that is in response to the flow of the currently processed data message. In some embodiments, the service classifier uses the same SPI record for the forward flow and reverse flow. In other embodiments, the service classifier creates separate connection tracker flows for the forward and reverse flows. Some embodiments use the same SPI for the reverse flow in order to ensure that the same set of service containers examine both the initial data message flow in the forward direction and the responsive data message flow in the reverse direction.

After storing the record(s) in the connection tracker 410, the service classifier transitions to 330. The process also transitions to 330 from 310 when it determines that it has previously processed the received data message's flow, identifies the SPI for this flow from the connection tracker and then uses this SPI to identify the service containers in the service path for the data message.

At 330, the service classifier passes the data message to the service forwarding element to forward to the first service container. In some embodiments, the service classifier provides the specified service path identifier to the service forwarding element to use to perform its classification operations for forwarding the data messages of this flow. In other embodiments, the service forwarding element does not use the service path identifier for forwarding the data messages of the particular data message flow, but rather uses a MAC redirect approach.

In some embodiments, the service classifier specifies the data message's destination MAC address as the MAC address of the first service container and provides this data message to service forwarding element to forward to the first service container. In other embodiments, the service classifier specified the data message's destination MAC as a MAC address associated with the service forwarding element, which uses the data message's source MAC address to perform its service forwarding operation, as further described below. In some of these embodiments, the service classifier specifies the source MAC address as a MAC address associated with the start of a particular service path to allow the service forwarding element to identify the first service container for the service path.

After 330, the service classifier increments statistics of the service containers in the identified service path. As mentioned above, the service classifier maintains these statistics in the statistic storage 424. Different statistics are maintained in different embodiments. Examples of such statistics include number of data messages, number of bytes in the forwarded payload bytes, etc. Hence, in some embodiments, the service classifier increments the statistics by incrementing each service container's message count by one, and/or adding the processed message's payload size to the byte count of each service container in the service path. After 330, the process 300 ends.

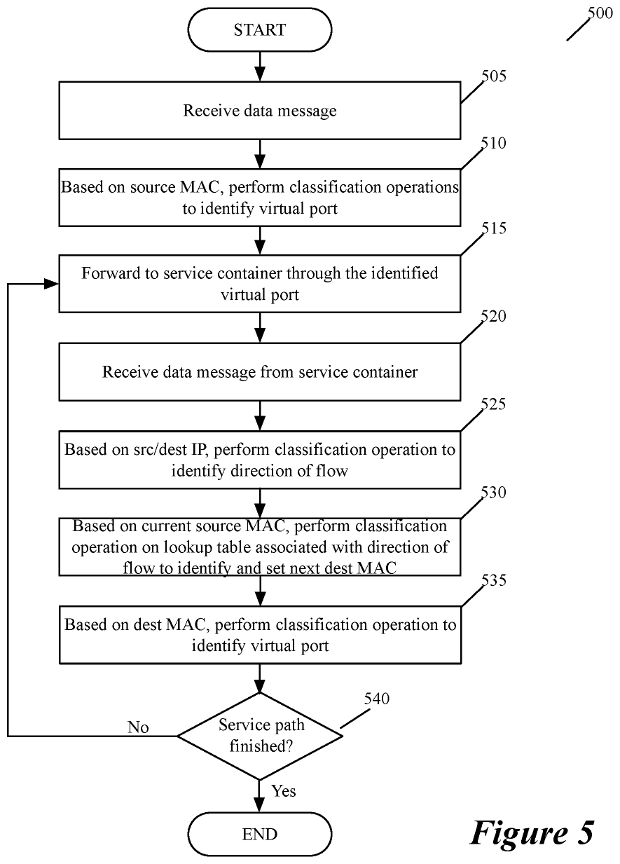

FIG. 5 presents a process 500 that conceptually illustrates the operation of the service forwarding element 160 in forwarding a data message through a service path identified by the service classifier 155. This forwarding operation uses MAC redirect and is implemented in part by a Linux bridge 240 inside its root namespace 215, and in other part by hook functions in the virtual interface endpoints (e.g., Ethernet ports 206) of the service containers and in the virtual interface endpoints (e.g., Ethernet ports 208) defined in the Linux namespace. These virtual interface endpoints are configured to perform match-action forwarding operations needed for implementing the MAC redirect forwarding.

As shown, the process 500 starts (at 505) when it receives a data message for forwarding through the service path. Next, at 510, the process performs a classification operation to identify the virtual interface endpoint of the Linux bridge associated the first service node. As mentioned above, the service classifier in some embodiments defines this destination MAC to be the destination MAC of the virtual interface endpoint connected to the first service container. In some of these embodiments, the classification operation (at 510) compares the data message's destination MAC with the match criteria of forwarding rules in a lookup table that associates different destination MAC address with different virtual interface endpoint identifiers. Under this approach, the process retrieves the identifier for the next hop virtual interface endpoint from the forwarding rule that has the data message's destination MAC as its match criteria.

In other embodiments, the process 500 performs the classification operation differently. For instance, in some embodiments, the process 500 uses the below-described three classification operations 525-535, which first identify the direction of the service flow, then use the source MAC of the data message to identify the destination MAC of the first service node, and lastly use the identified destination MAC to identify the virtual interface endpoint. In some of these embodiments, the service classifier does not set the data message's destination MAC address to be the MAC address of the first service node, but instead sets this address to be the destination MAC address of the bridge.

Next, at 515, the process forwards the data message to the next service container through the identified virtual interface endpoint. The service container performs its service operation (e.g., middlebox service operation, etc.) on the data message, and then provides (at 520) the data message back to the service forwarding element. In some embodiments, the service container 235, its associated Ethernet port 206, or the associated bridge interface endpoint 208 changes the source MAC address of the data message to be a MAC address associated with the service container (e.g., associated with its Ethernet port 206), as the service forwarding element uses source MAC addresses to perform its next-hop service determination.

The process 500 then performs three classification operations at 525, 530 and 535, which were briefly mentioned above. The first classification operation (at 525) compares the L3 source and/or destination network addresses of the data message with classification rules that are defined to differentiate egress data messages from ingress data messages. For instance, in some embodiments, one classification rule determines whether the data message's source L3 address is in the CIDR of SDDC subnet in order to determine whether the data message is part of an upstream flow exiting the subnet, while another classification rule determines the data message's destination L3 address is in the CIDR of SDDC subnet in order to determine whether the data message is part of downstream flow entering the subnet.

In some embodiments, each of these classification rules identifies a different lookup table for performing the second classification operation at 530. Hence, after identifying the direction of the data message's flow (upstream or downstream) in the first classification operation at 525, the process 500 uses the lookup table identified by the first classification operation to perform the second lookup at 530, this time based on the current source MAC address of the data message. In some embodiments, this second classification rule matches the data message's current source MAC address with the match criteria (specified in terms of a source MAC) of one classification rule that provides in its action tuple the destination MAC of the next hop along the service path. The source MAC identifies the prior service node in the service chain for the direction identified at 525 (e.g., in the table identified at 525), and hence can be used to identify the next service node in the service chain.

In some embodiments, the second classification operation (at 530) changes the data message's destination MAC address to the MAC address of the next hop in the service path. When the service path has not been completed (i.e., when the last service container has not yet processed the data message), the next hop in the service path is another service container. On the other hand, when the service path has finished (i.e., when the last service container has processed the data message), the next hop in the service path is an egress destination MAC that has been defined for the service path. This egress destination MAC in some embodiments is a MAC address associated with a switch or router that forwards the data message to another destination in the SDDC, or is a MAC address associated with a gateway that forwards the data message out of the SDDC or an SDDC subnet.

After the destination MAC of the data message is redefined at 530, the process performs a third classification operation (at 535) to identify the virtual interface endpoint of the Linux bridge associated with the data message's destination MAC. This classification operation in some embodiments compares the data message's destination MAC with the match criteria of forwarding rules in a lookup table that associates different destination MAC address with different virtual interface endpoint identifiers. Under this approach, the process retrieves the identifier for the next hop virtual interface endpoint from the forwarding rule that has the data message's destination MAC as its match criteria.

After 535, the process 500 determines (at 540) whether the identified virtual interface endpoint identified at 535 is that of another service container. When the identified virtual interface endpoint is not another service container, the service path has been completed. The operation 540 in some embodiments is not actually performed by the service forwarding element but is included only to illustrate the end of the service path in FIG. 5.

When the identified virtual interface endpoint identified at 535 is that of another service container, the service path forwarding of the process 500 has not finished. Hence, the process returns to 515 to forward the data message to the next service container on the path through its identified virtual interface endpoint. Otherwise, the service-path forwarding process 500 ends. As mentioned above, when the service path finishes, the destination MAC address that was defined in the last iteration through 530 identifies the virtual interface endpoint of the egress port that is defined for the service path. Hence, at the end of the service path in these embodiments, the Linux bridge forwards that the data message to the virtual interface endpoint from where it will be forwarded to its next destination.

The following example by reference to the host computer of FIG. 2 further illustrates the MAC-redirect forwarding of the service forwarding element of some embodiments. In this example, the service path includes the service container 235a followed by the service container 235b for an upstream data message on which two service operations have to be performed on the data message's way out of the SDDC. When the Linux bridge 240 receives this upstream data message, the data message has a destination MAC address of the vethx interface of the bridge, as it needs to be first processed by the service container 235a.

Hence, the bridge passes the data message to the vethx interface, which in turn forwards it to the service container 235a through the etho interface 206 of this service container. The service container performs its service on the data message, and passes it back to vethx interface through the etho interface. In passing the data message back to the vethx interface, the service container or its associated etho interface specifies the source MAC address of the data message as the source MAC address of the etho interface.

The vethx interface then performs a first classification operation, which based on the data message's L3 source address being in the ingress CIDR, results in a determination that the data message is in an upstream direction. Based on this determination, the vethx interface performs a second classification operation on an upstream lookup table that matches the current source MAC address with a next hop forwarding rule that identifies the next hop's destination MAC address. After the vethx interface identifies the next hop address to be the MAC address of vethy interface, the bridge provides the data message to the vethy interface. The vethy interface forwards the data message to the service container 235b through the etho interface 206 of this service container. The service container performs its service on the data message, and passes it back to vethy interface through the etho interface. Again, the source MAC address of the data message is changed to the source MAC address of etho interface of the service container 235b.

The vethy interface then performs a first classification operation, which based on the data message's L3 source address being in the ingress CIDR, results in a determination that the data message is in an upstream direction. Based on this determination, vethy interface performs a second classification operation on am upstream lookup table that matches the current source MAC address with a next hop forwarding rule that identifies the next hop's destination MAC address. In this case, the next hop address is that of the egress L2 address of the bridge. Hence, after the vethy interface identifies the next hop address to be the egress MAC address of the bridge, the bridge provides the data message to its egress interface for forwarding out of the host computer.

The service forwarding element 160 uses other forwarding methods in other embodiments. For instance, in some embodiments, the service forwarding element use the SPI for the identified service path and a current hop count to perform its forwarding operations. In some embodiments, the SPI and current hop count are values that the service classifier initially creates and stores on the host computer. For each service hop, the service forwarding element compares the SPI and the current hop count with match-criteria of next hop forwarding rules, which have action tuples that provide the virtual endpoint interface identifier for the virtual interface connected to the next hop. As the service forwarding element forwards the data message through its successive service hops, it adjusts (e.g., decrements) its current hop count to correspond to the next service container position in the service path.

In some embodiments, the service forwarding element uses the SPI/hop-count approach when the service containers execute on different host computers and/or execute in different datacenters. In some such embodiments, the SPI/hop-count information is embedded in tunnel headers that encapsulate the data messages as they are forwarded between the different host computers and/or different datacenters.

As mentioned above, the SDDC 100 in some embodiments has several host computers that execute sets of service containers for performing the same service chain on data message flows received at the datacenter. In some such embodiments, the host computers only execute service containers that perform operations associated with service chains, and do not execute any other data compute end node (i.e., any other a container or virtual machine that is the source or destination machine for a data message flow). In these embodiments, other host computers in the SDDC 1000 execute the machines as serve as the compute end nodes.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

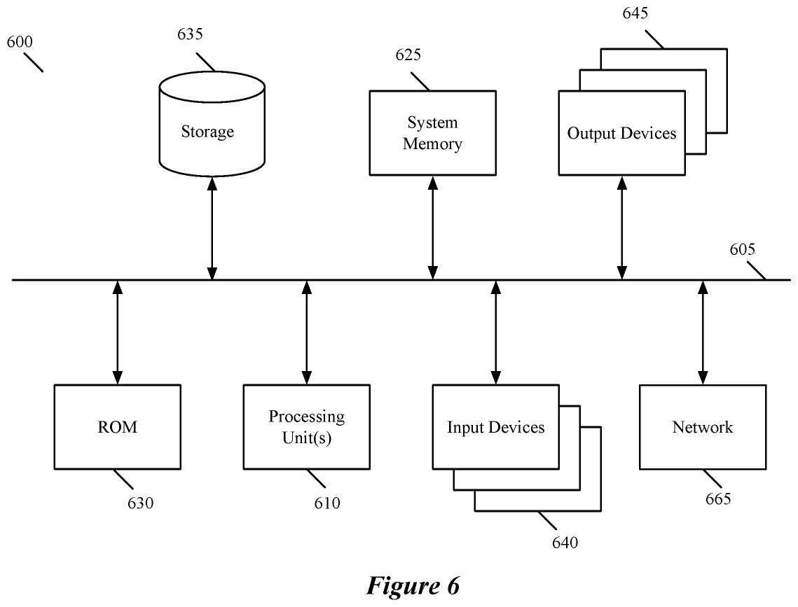

FIG. 6 conceptually illustrates a computer system 600 with which some embodiments of the invention are implemented. The computer system 600 can be used to implement any of the above-described hosts, controllers, and managers. As such, it can be used to execute any of the above described processes. This computer system includes various types of non-transitory machine readable media and interfaces for various other types of machine readable media. Computer system 600 includes a bus 605, processing unit(s) 610, a system memory 625, a read-only memory 630, a permanent storage device 635, input devices 640, and output devices 645.

The bus 605 collectively represents all system, peripheral, and chipset buses that communicatively connect the numerous internal devices of the computer system 600. For instance, the bus 605 communicatively connects the processing unit(s) 610 with the read-only memory 630, the system memory 625, and the permanent storage device 635.

From these various memory units, the processing unit(s) 610 retrieve instructions to execute and data to process in order to execute the processes of the invention. The processing unit(s) may be a single processor or a multi-core processor in different embodiments. The read-only-memory (ROM) 630 stores static data and instructions that are needed by the processing unit(s) 610 and other modules of the computer system. The permanent storage device 635, on the other hand, is a read-and-write memory device. This device is a non-volatile memory unit that stores instructions and data even when the computer system 600 is off. Some embodiments of the invention use a mass-storage device (such as a magnetic or optical disk and its corresponding disk drive) as the permanent storage device 635.

Other embodiments use a removable storage device (such as a floppy disk, flash drive, etc.) as the permanent storage device. Like the permanent storage device 635, the system memory 625 is a read-and-write memory device. However, unlike storage device 635, the system memory is a volatile read-and-write memory, such as random access memory. The system memory stores some of the instructions and data that the processor needs at runtime. In some embodiments, the invention's processes are stored in the system memory 625, the permanent storage device 635, and/or the read-only memory 630. From these various memory units, the processing unit(s) 610 retrieve instructions to execute and data to process in order to execute the processes of some embodiments.

The bus 605 also connects to the input and output devices 640 and 645. The input devices enable the user to communicate information and select commands to the computer system. The input devices 640 include alphanumeric keyboards and pointing devices (also called “cursor control devices”). The output devices 645 display images generated by the computer system. The output devices include printers and display devices, such as cathode ray tubes (CRT) or liquid crystal displays (LCD). Some embodiments include devices such as touchscreens that function as both input and output devices.

Finally, as shown in FIG. 6, bus 605 also couples computer system 600 to a network 665 through a network adapter (not shown). In this manner, the computer can be a part of a network of computers (such as a local area network (“LAN”), a wide area network (“WAN”), or an Intranet), or a network of networks (such as the Internet). Any or all components of computer system 600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, instead of selecting service containers to implement a service path, the service classifier of some embodiments selects service virtual machines to implement the service path. Thus, one of ordinary skill in the art would understand that the invention is not to be limited by the foregoing illustrative details, but rather is to be defined by the appended claims.

1. A method of performing services on a data message, the method comprising:
at a service classifier,
identifying, for the data message, a service chain comprising a plurality of services to perform on the data message;
identifying, for each service in the identified service chain, a service container for performing the service;
forwarding the data message to a service forwarding element to forward the data message through the service containers identified for the identified service chain.

2. The method of claim 1, wherein identifying a service container for each service in the identified service chain comprises performing at least one load balancing operation to select a particular service container from a set of two or more candidate service containers for at least one particular service.

3. The method of claim 2, wherein performing the load balancing operation comprises directing a load balancer that is specified for the particular service to select a container from the set of candidate service containers for the particular service.

4. The method of claim 2, wherein performing the load balancing operation comprises using statistics regarding data messages processed by each container in the container set to select one particular container from the set of containers for the data message.

5. The method of claim 1, wherein the data message is a first data message, the method further comprising:
associating the first data message with a service path identifier that identifies the containers selected for implementing the identified service chain for the first data message;
providing the service path identifier to the service forwarding element to provide to another service classifier to use to select the service path for a second data message that is sent in response to the first data message.

6. The method of claim 1, wherein
a group of service containers execute above an operating system of a host computer;
the operating system (OS) comprises an OS namespace used for performing match-action forwarding operations;
each service container comprises a container namespace;
the service forwarding element is implemented by configuring a virtual interface endpoint in the OS namespace for each service container in the group and by configuring a virtual interface endpoint in the container namespace of each service container.

7. The method of claim 6, wherein at least a set of the match-action forwarding operations comprise (i) matching classification operations that compare layer 2 destination network address of the data message and layer 3 source or destination network address of the data message with selection criteria of forwarding rules, and (ii) action operations that modify the layer 2 destination network address of the data message.

8. The method of claim 6, wherein the operating system is a Linux operating system and the namespace of the Linux operating system performs bridging forwarding operations.

9. The method of claim 1, wherein identifying a service chain comprises comparing a set of attributes associated with the data message with at least one selection criteria of at least one service-chain identifying rule to identify a service-chain identifying rule that matches the data message and specifies a service chain for the matching data message.

10. The method of claim 1, wherein
the matching service-chain identifying rule identifies a service-container selector for each service identified by the service-chain identifying rule; and
identifying a service container for each service in the identified service chain comprises directing the service-container selector to select a particular service container from a set of two or more candidate service containers for the service.

11. A non-transitory machine readable medium storing a service-classification program for execution by at least one processing unit to perform services on data messages passing through a network, the program comprising sets of instructions for:
identifying, for the data message, a service chain comprising a plurality of services to perform on the data message;
identifying, for each service in the identified service chain, a service container for performing the service;
forwarding the data message to a service forwarding element to forward the data message through the service containers identified for the identified service chain.

12. The non-transitory machine readable medium of claim 11, wherein the set of instructions for identifying a service container for each service in the identified service chain comprises a set of instructions for performing at least one load balancing operation to select a particular service container from a set of two or more candidate service containers for at least one particular service.

13. The non-transitory machine readable medium of claim 12, wherein the set of instructions for performing the load balancing operation comprises a set of instructions for directing a load balancer that is specified for the particular service to select a container from the set of candidate service containers for the particular service.

14. The non-transitory machine readable medium of claim 12, wherein the set of instructions for performing the load balancing operation comprises a set of instructions for using statistics regarding data messages processed by each container in the container set to select one particular container from the set of containers for the data message.

15. The non-transitory machine readable medium of claim 11, wherein the data message is a first data message, the program further comprising sets of instructions for:
associating the first data message with a service path identifier that identifies the containers selected for implementing the identified service chain for the first data message;
providing the service path identifier to the service forwarding element to provide to another service classifier to use to select the service path for a second data message that is sent in response to the first data message.

16. The non-transitory machine readable medium of claim 11, wherein
a group of service containers execute above an operating system of a host computer;
the operating system (OS) comprises an OS namespace used for performing match-action forwarding operations;
each service container comprises a container namespace;
the service forwarding element is implemented by configuring a virtual interface endpoint in the OS namespace for each service container in the group and by configuring a virtual interface endpoint in the container namespace of each service container.

17. The non-transitory machine readable medium of claim 16, wherein at least a set of the match-action forwarding operations comprise (i) matching classification operations that compare layer 2 destination network address of the data message and layer 3 source or destination network address of the data message with selection criteria of forwarding rules, and (ii) action operations that modify the layer 2 destination network address of the data message.

18. The non-transitory machine readable medium of claim 16, wherein the operating system is a Linux operating system and the namespace of the Linux operating system performs bridging forwarding operations.

19. The non-transitory machine readable medium of claim 11, wherein the set of instructions for identifying a service chain comprises a set of instructions for comparing a set of attributes associated with the data message with at least one selection criteria of at least one service-chain identifying rule to identify a service-chain identifying rule that matches the data message and specifies a service chain for the matching data message.

20. The non-transitory machine readable medium of claim 11, wherein
the matching service-chain identifying rule identifies a service-container selector for each service identified by the service-chain identifying rule; and
the set of instructions for identifying a service container for each service in the identified service chain comprises a set of instructions for directing the service-container selector to select a particular service container from a set of two or more candidate service containers for the service.

21. A method of performing services on a data message, the method comprising:
at a service classifier,
identifying, for the data message, a service chain comprising a plurality of services to perform on the data message;
identifying, for each service, a service node for performing each service in the identified service chain, wherein the identifying at least one particular service node for at least one particular service comprises performing a load balancing operation to select the particular service node from a set of two or more candidate service nodes for the particular service;
forwarding the data message to a service node identified for a first service in the identified service chain.
